(19) United States
(12) Patent Application Publication
(10) Pub. No.: US 2026/0226208 A1
(43) Pub. Date: Aug. 6, 2026

(54) PROCESS

(71) Applicant: INEOS EUROPE AG, Vaud (CH)

(72) Inventor: Philip Van Breuseghem, Temse (BE)

(21) Appl. No.: 19/142,291

(22) PCT Filed: Dec. 7, 2023
(86) PCT No.: PCT/EP2023/084777

§ 371 Date: Jun. 23, 2025

(30) Foreign Application Priority Data
Dec. 23, 2022 (EP) 22216416.2

(51) Int. Cl. C08F 110/02

(52) U.S. Cl. CPC C08F 110/02

(57) ABSTRACT

A process for producing a polyolefin includes reacting olefins in a polymerisation reactor, withdrawing a polymerisation effluent stream comprising polyolefin solids, passing the effluent to a first degassing vessel operating at a pressure, P1, passing the polyolefin solids from the first degassing vessel to a connecting vessel until there is collected in the connecting vessel a volume of polyolefin solids, reducing the pressure in the connecting vessel to a pressure, P2, via a vent line of the connecting vessel, and passing the polyolefin solids to a second degassing vessel-operating at a pressure, P3, wherein the volume of polyolefin solids collected is at least 50% of the volume of the connecting vessel, P2 is at least 20% lower than the pressure, P1, the connecting vessel has a cylindrical body, with a height/diameter ratio of less than 2, and the vent line is located above the collected volume of solids.

### FIELD AND BACKGROUND OF THE INVENTION

The present invention relates to the production of polyolefins, and in particular to processes for the production of polyolefins involving degassing vessels in series.

Production of polyolefins by polymerisation of an olefin monomer, optionally an olefin comonomer, in the presence of a polymerisation catalyst is a well-known and widely commercially operated process. Different polymerisation processes are known, including those operated in the gas phase or the slurry phase, or a combination thereof, and in different types of reactors, including slurry loop reactors, stirred tank slurry reactors, horizontally or vertically orientated agitated bed reactors and fluidised bed reactors.

All processes, to some extent, require separation of polyolefin product from unreacted monomers and, usually, from inert components such as diluents or inert gases, which are present during the polymerisation. The components to be separated usually include either the liquid or gas phase around the polyolefin particles, but also components which may initially be absorbed on or in the polyolefin particles. The removal of such components is generally referred to as degassing. Numerous steps which may be considered as degassing steps are known in the art. These include pressure reduction to vaporise liquid or assist desorption of absorbed components, and flushing or purging with gases to separate gas and vaporised components from the polymer.

Degassing may be, and usually advantageously is, performed in several steps in series. For example, for slurry polymerisation processes a first degassing step may be performed in which the slurry is heated and the pressure reduced to vaporise and remove most of the liquid components of the slurry for recycle. The polyolefin solids are then subjected to a further pressure reduction and purging with a gas, such as nitrogen, to remove remaining components.

WO 2005/003188 discloses a process for treating polyolefin discharged from a slurry polymerization process which comprises two degassing steps with an intermediate concentrator vessel. The process involves a sequence of filling and transfer to minimise hydrocarbon components which are passed to the downstream degassing step.

We have now found a process in which the transfer of polyolefin solids from a first to a second degassing vessel is further improved.

### SUMMARY OF THE INVENTION

Thus, the present invention provides a process for the production of a polyolefin, which process comprises:
a. Reacting one or more olefins in a polymerisation reactor to produce a polyolefin,
b. Withdrawing a polymerisation effluent stream comprising polyolefin solids,
c. Passing the effluent to a first degassing vessel in which the polyolefins solids are degassed, said degassing vessel operating at a pressure, P1,
d. Opening a solids inlet of a connecting vessel and passing the polyolefin solids from the first degassing vessel to the connecting vessel via the solids inlet and until there is collected in the connecting vessel a volume of polyolefin solids, and wherein, once the volume of polyolefin solids has been collected:
i. the solids inlet of the connecting vessel is closed,
ii. the pressure in the connecting vessel is reduced to a pressure, P2, via a vent line of the connecting vessel,
iii. after the pressure is reduced, a solids outlet of the connecting vessel is opened and the polyolefin solids are passed to a second degassing vessel via the solids outlet, and
iv. after passing the polyolefin solids to the second degassing vessel, the solids outlet is closed,
e. Degassing the polyolefin solids in the second degassing vessel, the second degassing vessel operating at a pressure, P3, characterised in that
i. the volume of polyolefin solids collected in step (d) prior to steps (i)-(iv) is at least 50% of the volume of the connecting vessel,
ii. P 2 is at least 20% lower than the pressure, P1,
iii. the connecting vessel has a cylindrical body, with a top section connected to the top of the cylindrical body and a bottom section connected to the bottom of the cylindrical body, wherein the cylindrical body has an H/D of less than 2, H being the height of the vessel and D being the diameter, and
iv. the vent line is located on the top section of the connecting vessel or on the upper part of the cylindrical body of the connecting vessel, but above the collected volume of solids.

### DETAILED DESCRIPTION OF THE INVENTION

The present invention provides a process for the production of a polyolefin. The process comprises reacting one or more olefins in a polymerisation reactor to produce a polyolefin. The process may be any suitable polymerisation process, including a fluidised bed gas phase process, a stirred bed gas phase process and a slurry phase process. The polyolefin is preferably a polyethylene or polypropylene. The one or more olefins are selected accordingly. Thus, for production of a polyethylene the one or more olefins will comprise ethylene, optionally with one or more other olefins as comonomer(s). For production of a polypropylene the one or more olefins will comprise propylene, optionally with one or more other olefins as comonomer(s).

Other reactants and components of the reaction mixture, such as hydrogen, inert hydrocarbons can be present as desired and as known in the art.

A process for the production of polyethylene by reacting one or more olefins comprising ethylene is most preferred.

The present invention is most preferably a slurry phase polymerisation process, most preferably for the production of polyethylene by reacting one or more olefins comprising ethylene.

There is withdrawn from the reactor a polymerisation effluent stream comprising polyolefin solids. In a gas phase process this typically comprises polymer solids and entrained gas, whilst in the slurry phase process this comprises polymer solids and liquid diluent mixture.

In most preferred embodiments the process is a process for production of polyethylene, which comprises reacting ethylene, and optionally one or more comonomers in one or more slurry loop polymerisation reactors to produce the polyethylene. The polymerisation effluent in such a process generally comprises polyethylene solids in a liquid diluent, which is most preferably isobutane.

The process may comprise a single slurry loop polymerisation reactor, or two or more slurry loop polymerisation reactors operated in parallel or, preferably, in series. Examples of suitable polymerisation processes include WO 2006/015807, WO 2005/003188 and WO 2013/135565. Where two or more polymerisation reactors in series are present, then the effluent of step (b) is the effluent withdrawn from the last reactor in the series. Where two or more polymerisation reactors in parallel are present, then separate effluents are withdrawn from each reactor in step (b), and these may preferably be combined before passing to the first degassing vessel, or may be passed separately to and then combined in the first degassing vessel.

The effluent is passed to a first degassing vessel in which the polyolefins solids are degassed. Degassing of polyolefins is well-known. In particular, the polyolefins solids are separated from the entrained gas in a gas phase process or vaporised diluent in a slurry phase process. The effluent may be heated prior to the degassing vessel, for example, to assist in vaporisation of diluent.

The degassing vessel operates at a pressure, P1. Preferably the pressure, P1, is at least 400 kPag, and more preferably at least 500 kPag, such as at least 700 kPag. The pressure, P1, is generally less than the pressure in the polymerisation reactor. P1 is typically less than 1500 kPag, and more usually less than 1200 kPag.

In slurry processes, as is known in the art, it is preferred that the first degassing vessel is at a pressure which is high enough that the vaporised diluent can be condensed using cooling water and without compression being required, this enabling efficient recycle to the reactor.

In general, it is desirable to separate the majority of the components of the withdrawn effluent other than the polyolefin solids from the polyolefin solids in the first degassing vessel, so that they can be recycled at the relatively high pressure therein. (The second degassing vessel, as will be described hereinafter, removes remaining or residual components of the effluent (other than the solids) at a lower pressure, which has increased cost to recycle.)

In the process of the present invention there is provided a connecting vessel between the first and second degassing vessels. During the process of the present invention a solids inlet of the connecting vessel is opened, and the polyolefin solids are then passed from the first degassing vessel to the connecting vessel via the solids inlet.

This takes place until there is collected in the connecting vessel a volume of polyolefin solids (which may be considered as a “desired volume”), which according to the present invention is at least 50% of the volume of the connecting vessel.

Preferably the volume of polyolefin solids collected in step (d) prior to steps (i)-(iv) is at least 60%, such as 60 to 85% of the volume of the connecting vessel.

The connecting vessel is preferably located directly below the first degassing vessel. This enables the transfer of the polyolefins solids to take place both using the pressure, P1, in the first degassing vessel and also using gravity. This latter, whilst not essential, can assist in obtain a high level of polyolefin solids even when pressures have equalised.

Once the volume of polyolefin solids has been collected the solids inlet of the connecting vessel is closed and the pressure in the connecting vessel is reduced. The pressure reduction is achieved by opening of the vent line of the connecting vessel, and in particular by opening of a valve on the vent line, to release gas from the connecting vessel. This is done until the pressure, P2, is reached.

P2 is preferably at least 30% lower than P 1, such as at least 50% lower than P 1

In absolute terms the pressure is typically reduced to less than 400 kPag, such as less than 300 kPag. P2 is typically at least 100 kPag, such as at least 250 kPag.

In preferred embodiments the gas from the connecting vessel may be vented via the vent line to a second, parallel, connecting vessel. Having two or more parallel connecting vessels allows the first degassing vessel to discharge to one connecting vessel whilst another connecting vessel is discharging to the second degassing vessel. This enables a higher throughput.

In embodiments, in particular where a parallel connecting vessel is not present, the gas from the connecting vessel may be vented via the vent line to a vessel at a pressure lower than P1, for example, and preferably, to the second degassing vessel. The vent line in this embodiment may connect to the upper half, and preferably to at or close to the top, of the second degassing vessel.

In particularly preferred embodiments, the vent line is designed to minimise the entrainment of polyolefin solids during the venting step. For example, the vent line may have an internal diameter of from 1.25 cm (0.5 inch) to 7.5 cm (3 inches), preferably from 2.5 cm (1 inch) to 5 cm (2 inches), this being selected to provide a relatively rapid degassing of the connecting vessel without too large a linear gas flow rate (i.e. velocity) in the connecting vessel.

In embodiments, the connecting vessel may be provided with both a first vent line which connects to a second, parallel, connecting vessel and a second vent line which connects the connecting vessel to a vessel at a pressure lower than P1, and preferably to the second degassing vessel (and these being as described already). The first vent line is preferably used for the pressure reduction in step (d)(ii) of the present invention i.e. after filling of the connecting vessel. The second vent line can be opened temporarily, and optionally more than once, during the filling of the connecting vessel to allow gas release from the connecting vessel, and to reduce the pressure therein during the filling.

In embodiments, the connecting vessel may be provided with a high pressure line (with a valve) and which connects the connecting vessel, typically from the upper half, and preferably from at or close to the top thereof, to the first degassing vessel, again typically to the upper half, and preferably to at or close to the top thereof. For avoidance of doubt, this high pressure line, when present, is provided in addition to the solids inlet of the connecting vessel and to the vent line (or lines). This high pressure line, when opened, allows gas flow from the connecting vessel to the first degassing vessel. This can provide equilibration of the pressures and/or provide an improved solids flow from the first degassing vessel to the connecting vessel. This high pressure line may, in preferred embodiments, be 5 cm (2″) to 20 cm (8″) in internal diameter.

For avoidance of doubt, the term “high pressure line” is not used to indicate specific pressure requirements per se, but simply to reflect that the line is connected to a vessel at relatively high pressure (namely the first degassing vessel, which is at a pressure P1).

In general, where first and second vent lines and a high pressure line are all present, the second vent line may be used (i.e. the valve on the line opened) at a relatively earlier stage to reduce the pressure during the filling of the connecting vessel, whilst the high pressure line may be used at a relatively later stage of the filling. The lines should generally not be used (have their valves open) at the same time. Once the (desired) volume of polyolefin solids has been collected in the connecting vessel, then the solids inlet of the connecting vessel is closed. The high pressure line and second vent line should also be closed if this is not already the case. Then the pressure in the connecting vessel is reduced to a pressure, P2, via the first vent line. In particular, once the volume of polyolefin solids has been collected the pressure in the connecting vessel is largely equilibrated with the pressure in the first degassing vessel, and will be approximately equal to P1.

After the pressure is reduced, a solids outlet of the connecting vessel is opened and the polyolefin solids are passed to a second degassing vessel via the solids outlet. Once the polyolefin solids in the connecting vessel have been passed to the second degassing vessel, the solids outlet is closed.

It will be noted that at this stage the solids inlet of the connecting vessel can be opened to the first degassing vessel again, and another cycle of filling and pressure reduction performed. Preferably, before this happens, the connecting vessel is at least partially repressurised. In embodiments with a second, parallel, connecting vessel, this may be performed by venting, via the vent line, the (second) parallel connecting vessel to the (first) empty connecting vessel. In particular, the gas released by depressurising a filled, parallel, connecting vessel (from P1 to the pressure P2) can be used to increase the pressurise in the empty connecting vessel. Alternatively, and in particular where a parallel concentrator vessel is not present, repressurisation may be obtained using gas from the first degassing vessel or elsewhere.

Partial repressurisation allows the collecting vessel to be checked for leaks before filling with solids commences.

More generally, the polyolefin solids passed to the second degassing vessel are then degassed therein. The second degassing vessel operates at a pressure, P3. P3 is less than P1. The second degassing step is also generally as known in the art.

Suitably the pressure, P 3, is less than 100 kPag, and more typically is less than 50 kPag.

Degassing in the second degassing vessel may comprise use of a purge gas, again as known in the art, to remove residual hydrocarbons (from the effluent).

As already noted, the present invention is characterised in that the volume of polyolefin solids collected in step (d) prior to steps (i)-(iv) is at least 50% of the volume of the connecting vessel.

A “large” fill of the connecting vessel is advantageous because it means there is less volume of the connecting vessel which is filled with other components of the effluent. Thus, this minimises the volume of such components subsequently transferred to the second degassing vessel with the polyolefin (and hence as a proportion of the polyolefin transferred).

However, the increased amount of polyolefin solids generally increases the risk of entrainment of polyolefin solids during the reduction of pressure of the connecting vessel. We have found that this is minimised by the selection of a maximum H/D for the connecting vessel, and in particular so H/D is less than 2. This finding may be considered surprising since, for a particular “fill” e.g. 70%, of the connecting vessel, the surface of the polyolefin solids would be physically closer in height to the gas outlet in a vessel with lower H/D than in a vessel with higher H/D. We have found, however, that the physical separation of the solids from the gas outlet is less important than the initial gas velocity when the connecting vessel is depressurised, and a lower H/D ratio is advantageous.

In preferred embodiments, H/D is less than 1.5, such as between 0.5 and 1.5.

Further, the entrainment during the pressure reduction to a pressure P2 is also minimised by ensuring that the vent line (through which the pressure reduction occurs) is located at or close to the top of the connecting vessel. In preferred embodiments the vent line is located on the top section, and preferably as close to the top of this as possible. However, it can be on the upper part of the cylindrical body, and in particular on the top 10% of the cylindrical body, as long as it is above the collected volume of solids. Where a second vent line and/or a high pressure line are present then the same preferred locations are applicable also to these lines.

(It will be noted that the collected volume of solids will generally not have a flat surface, but be in the shape of a cone. The vent line (and other lines if present) should be located above the surface of the cone at the side of the cylindrical body.)

More generally, the top section of the connecting vessel is preferably in the approximate shape of a hemisphere or cone, with a maximum height in the centre. The top section preferably has an average angle to the horizontal (taken as the angle to the horizontal of a line drawn between the top at the centre of the top section and the side where the top section connects to the cylindrical section which is similar to the angle of repose of the polyolefin solids, and in particular within 20° of the angle of repose. This enables, if desired, the top section to also be filled with polyolefin solids whilst minimising the free space between the surface of the collected polyolefins solids and the top of the connecting vessel.

In embodiments all or parts of one or more of the first degassing vessel, the connecting vessel and the second degassing vessel may be polished or provided with a liner, and in particular a liner that provides low friction. In particular, polishing or use of a liner can provide for improved powder flow. Typically, for example, the bottom of the first degassing vessel will be in the form of a cone, and this may be polished or provided with a lining to aid the flow of the polyolefin solids out of the first degassing vessel (and to the connecting vessel). Similarly, the bottom of the connecting vessel will typically be in the form of a cone, and at least this part of the connecting vessel may be polished or provided with a lining (independently of whether any part of the first degassing vessel is polished or provided with a lining), to aid the flow of the polyolefin solids out of the connecting vessel. And similarly again, the bottom of the second degassing vessel will typically be in the form of a cone, and this may be polished or provided with a lining to aid the flow of the polyolefin solids out of the second degassing vessel (to downstream processing or storage). (And this being independent of whether the first degassing vessel and/or connecting vessel are polished or provided with linings.)

Connecting lines and the internal pipework in components such as valves can also be polished, or where suitable, provided with linings to aid flow of the polyolefin solids.

As noted above, entrainment is also further minimised by careful selection of the diameter of the vent line. Thus, the internal diameter of the vent line is typically from 1.25 cm (0.5 inch) to 7.5 cm (3 inches), preferably from 2.5 cm (1 inch) to 5 cm (2 inches), this being selected to provide a relatively rapid degassing of the connecting vessel without too large a linear gas flow rate in the connecting vessel.

### Example

The present Example illustrates a process according to the present invention, and in particular with two connecting vessels provided in parallel.

Ethylene is polymerised in the presence of isobutane diluent and a polymerisation catalyst in a slurry polymerisation system comprising two slurry loop reactors in series, to produce a high density polyethylene (HDPE). Reaction is performed at about 4000 kPag.

A slurry stream comprising HDPE and diluent is withdrawn continuously from the second polymerization reactor at a rate of 42000 kg/hr of HDPE and 53000 kg/hr of diluent phase. The slurry stream is depressurised and heated, and then passed into a first degassing vessel operating at a pressure, P1, of 800 kPag. In the first degassing vessel degassing occurs with separation of vaporised diluent phase, including unreacted olefin monomers, from the HDPE solids, and with the majority of the vaporised phase discharged from the top of the first degassing vessel. The HDPE and the remaining part of the vaporised diluent phase is discharged into one of two connecting vessels (“first” and “second” connecting vessels) provided in parallel, through a valved solids inlet at the top of the connecting vessel. Each connecting vessel also has a valved solids outlet at its base and connected to a second degassing vessel. The second degassing vessel is operated at a pressure, P3, of 30 kPag.

Each connecting vessel has a cylindrical section with a ratio of height to inner diameter of 0.875, and (2) conical heads on both ends of the cylindrical section. The connecting vessels have a nominal volume of 2 m³.

A first vent line connects the two connecting vessels to each other. In particular, the first vent line has a 5 cm (2 ″) internal diameter and connects the upper conical head of one connecting vessel to the upper conical head of the other. Each connecting vessel is also provided with a second vent line which has an internal diameter of 2.5 cm (1″) and which connects from the top conical head of the connecting vessel to the top of the second degassing vessel, and a 15 cm diameter (6″) high pressure line which connects from the top conical head of the connecting vessel to the top of the first degassing vessel. (These are provided in addition to the solids inlet and solids outlets of the connecting vessel.)

The sequence to discharge HDPE from the first degassing vessel begins with the opening of the solids inlet valve of the (first) connecting vessel. Prior to opening of the solids inlet the connecting vessel is at a pressure of 250 kPag. The connecting vessel begins to fill with solids. After 5 seconds, a valve on the second vent line connecting the top of the connecting vessel to the inlet of the second degassing vessel is partially opened for 3 seconds to allow vapor to leave from the connecting vessel. After this valve is closed, a valve on the high pressure line connecting the top conical head of the connecting vessel to the top of the first degassing vessel is opened to allow the vapor space in the two vessels to equilibrate. Filling continues and the connecting vessel reaches a level of 60% fill (i.e. the volume of polymer solids is 60% of the volume of the connecting vessel). At this point, the solids inlet valve of the connecting vessel is closed, as is the valve on the high pressure line connecting the connecting vessel to the first degassing vessel. The pressure in the connecting vessel after filling is 800 kPag (i.e. same as the first degassing vessel).

The pressure in the connecting vessel is reduced to a pressure, P2, of 250 kPag by opening the first vent line which connects the connecting vessel to the parallel connecting vessel for 10 seconds. (The second connecting vessel is also then at a pressure of 250 kPag.)

(It may be noted that in a system without two parallel concentrator vessels a vent line connecting the concentrator vessel to the second degassing vessel may be used as the vent line in this step, and the pressure in the connecting vessel reduced by opening this line for a suitable period of time.)

After the pressure in the connecting vessel is reduced, the solids outlet valve of the connecting vessel is opened. The HDPE solids are passed to the second degassing vessel via the solids outlet of the connecting vessel.

The solids outlet valve is closed after 15 seconds by which time the connecting vessel is empty of HDPE solids and at a pressure of 30 kPag, which is the pressure of the second degassing vessel.

Degassing of the HDPE solids in the second degassing vessel takes place at a pressure, P 3, of 30 kPag.

Whilst the first connecting vessel is emptying to the second degassing vessel, the inlet valve of the second connecting vessel is opened so that this can fill with HDPE from the first degassing vessel at the same time. The equivalent sequence is performed, including venting from the second degassing vessel to the first after filling of the second degassing vessel (and emptying of the first degassing vessel) has completed. In particular, after the solids inlet of the second connecting vessel and the solids outlet of the first connecting vessel have been closed the first vent line is opened to connect the second connecting vessel to the first connecting vessel. The second connecting vessel reduces to a pressure of 250 kPag, which the first connecting vessel is repressurised, also to 250 kPag, ready for filling again.

The filling step and emptying steps for the connecting vessels can then repeat.

1. A process for the production of a polyolefin, which process comprises:
a. reacting one or more olefins in a polymerisation reactor to produce a polyolefin,
b. withdrawing a polymerisation effluent stream comprising polyolefin solids,
c. passing the effluent from the effluent stream to a first degassing vessel in which the polyolefins solids are degassed, said first degassing vessel operating at a pressure, P1,
d. opening a solids inlet of a connecting vessel and passing the polyolefin solids from the first degassing vessel to the connecting vessel via the solids inlet and until there is collected in the connecting vessel a volume of polyolefin solids, and wherein, once the volume of polyolefin solids has been collected:
i. the solids inlet of the connecting vessel is closed,
ii. the pressure in the connecting vessel is reduced to a pressure, P2, via a vent line of the connecting vessel,
iii. after the pressure is reduced, a solids outlet of the connecting vessel is opened and the polyolefin solids are passed to a second degassing vessel via the solids outlet, and
iv. after passing the polyolefin solids to the second degassing vessel, the solids outlet is closed,
e. degassing the polyolefin solids in the second degassing vessel, the second degassing vessel operating at a pressure, P3, wherein
i. the volume of polyolefin solids collected in step (d) prior to steps (i)-(iv) is at least 50% of a volume of the connecting vessel,
ii. P2 is at least 20% lower than the pressure, P1,
iii. the connecting vessel has a cylindrical body, with a top section connected to a top of the cylindrical body and a bottom section connected to a bottom of the cylindrical body, wherein the cylindrical body has an H/D of less than 2, H being a height of the vessel and D being a diameter, and
iv. the vent line is located on the top section of the connecting vessel or on an upper part of the cylindrical body of the connecting vessel, but above the collected volume of solids.

2. The process according to claim 1 wherein the process is a process for production of polyethylene, which comprises reacting ethylene, and optionally one or more comonomers in one or more slurry loop polymerisation reactors to produce the polyethylene.

3. The process according to claim 1 wherein the degassing vessel operates at a pressure, P1, which is at least 500 kPag.

4. The process according to claim 1 wherein the connecting vessel is located directly below the first degassing vessel to enable a transfer of the polyolefins solids to take place both using the pressure, P1, in the first degassing vessel and also using gravity.

5. The process according to claim 1 wherein the volume of polyolefin solids collected in step (d) prior to steps (i)-(iv) is at least 60% of the volume of the connecting vessel.

6. The process according to claim 1 wherein the pressure in the connecting vessel is reduced to the pressure, P2, which is at least 50% lower than P1.

7. The process according to claim 1 wherein a gas from the connecting vessel is vented to a second, parallel, connecting vessel.

8. The process according to claim 1 wherein the vent line has an internal diameter of from 1.25 cm (0.5 inch) to 7.5 cm (3 inches).

9. The process according to claim 1 wherein, after the polyolefin solids in the connecting vessel have been passed to the second degassing vessel, the solids outlet is closed, and the connecting vessel is at least partially repressurised.

10. The process according to claim 9 wherein the connecting vessel is connected, via the vent line, to a parallel connecting vessel and the repressurisation takes place using gas released by depressurising the filled, parallel, connecting vessel.

11. The process according to claim 1 wherein the pressure, P3, is less than 100 kPag.

12. The process according to claim 1 wherein the degassing in the second degassing vessel comprises use of a purge gas to remove residual hydrocarbons.

13. The process according to claim 1 wherein H/D is less than 1.5.

14. The process according to claim 1 wherein the vent line is located on the top section of the connecting vessel or on the upper part of the cylindrical body of the connecting vessel.

15. The process according to claim 1 wherein the top section of the connecting vessel is in an approximate shape of a hemisphere or cone, with a maximum height in a centre and has an average angle to a horizontal which is within 20° of an angle of repose of the polyolefin solids.
